(19) United States
(12) Patent Application Publication
(10) Pub. No.: US 2024/0396120 A1
(43) Pub. Date: Nov. 28, 2024

(54) CYLINDRICAL TYPE BATTERY LIQUID IMMERSION COOLING SYSTEM

(71) Applicant: HYUNDAI MOBIS CO., LTD., Seoul (KR)

(72) Inventor: Yoo Jeong LEE, Seoul (KR)

(73) Assignee: HYUNDAI MOBIS CO., LTD., Seoul (KR)

(21) Appl. No.: 18/203,278

(22) Filed: May 30, 2023

(30) Foreign Application Priority Data
May 24, 2023 (KR) 10-2023-0066758

(51) Int. Cl. H01M 10/6568; H01M 10/613; H01M 50/244

(52) U.S. Cl. CPC H01M 10/6568; H01M 10/613; H01M 50/244

(57) ABSTRACT

Provided is a battery pack cooling system. A cylindrical type battery liquid immersion cooling system of the present disclosure may have a lighter weight and higher cooling performance than a conventional liquid immersion cooling system by using an absorbent material including a cooling fluid inside, may be continuously cooled with a limited amount of the fluid by evaporating and condensing the cooling fluid included in the absorbent material, and may achieve the higher cooling performance by using latent heat of the evaporation.

### CROSS-REFERENCE TO RELATED APPLICATIONS

This application claims priority under 35 U.S.C. § 119 to Korean Patent Application No. 10-2023-0066758, filed on May 24, 2023, in the Korean Intellectual Property Office, the disclosure of which is incorporated herein by reference in its entirety.

### TECHNICAL FIELD

The following disclosure relates to a battery pack cooling system.

### BACKGROUND

Air mobility requires high power that is 2 to 3 times greater than that of existing electric vehicles, and simultaneously requires a light weight as an important design factor. However, a heat value of a battery may be increased as output of the battery is increased. A water-cooling method or an air-cooling method, which is used in most electric vehicles currently in mass production, requires replacing the battery and a cooling fluid line together when replacing the battery. Therefore, this method is not suitable for replaceable batteries, and has limitations in temperature management of high-performance batteries.

Accordingly, a conventional technology adopts a liquid immersion cooling method, which has an advantage in cooling performance. However, in the liquid immersion cooling, an amount of a cooling fluid may be considerable because an entire mobility battery is filled with the fluid, and a weight of the battery may be greatly increased because the density of an insulating fluid mainly used for the liquid immersion cooling is typically twice that of water. In addition, even when only a portion of the battery is filled with the cooling fluid, movement of the cooling fluid is restricted, and it is thus difficult to uniformly cool all battery cells in the mobility battery having various movements.

### RELATED ART DOCUMENT

### [Patent Document]

(Patent Document 1) Korean Patent Laid-Open Publication No. 10-2022-0118823, entitled “VEHICLE BATTERY COOLING SYSTEM IN FAST CHARGING SYSTEM”

### SUMMARY

An embodiment of the present disclosure is directed to providing a cylindrical type battery liquid immersion cooling system having a lighter weight and higher cooling performance than a conventional liquid immersion cooling system by using an absorbent material including a cooling fluid inside thereof.

Another embodiment of the present disclosure is directed to providing a cylindrical type battery liquid immersion cooling system which may be continuously cooled with a limited amount of the fluid by evaporating and condensing the cooling fluid included in the absorbent material, and may achieve the higher cooling performance by using latent heat of the evaporation.

In one general aspect, a cylindrical type battery liquid immersion cooling system includes: a cooling unit cooling a battery cell by being in contact with a surface of the battery cell; and a fixing unit supporting the cooling unit including a mounting part and a partition, the mounting part being in contact with the cooling unit to attach the cooling unit to the battery cell, and the partition partitioning a space including the at least one battery cell, wherein the cooling unit includes a porous absorbent member including a cooling fluid flowing the inside and outside thereof and cooling the battery cell.

The partition may provide a space including a unidirectional row of the battery cells, and the battery cell included in the space partitioned by the partition may be cooled by the single cooling unit.

The partition may be a flat plate extending in one direction and sandwiched between the unidirectional rows of the battery cells.

The partition may be a plate having open top and bottom, having a side surface at least partially corresponding to that of the unidirectional row of the battery cells, and including a curved surface.

The mounting part may be a step protruding from the partition to the battery cell.

The cooling unit may have a shape of a closed strip including all of the unidirectional rows of the battery cells inside, corresponding to a side surface of the unidirectional row of the battery cells to cover an entire side surface of the battery cell, and having the same thickness as a height of the battery cell.

The cooling unit may have a shape of an open strip having the same thickness as a height of the battery cell, may be attached to one side of a side surface of a first battery cell which is one of the battery cells, and may be attached to the other side of a side surface of a second battery cell which is included in the same row as that of the first battery cell and adjacent to the first battery cell.

The system may further include: a case embedding the plurality of battery cells, the cooling unit, and the fixing unit inside; and a cooling plate attached to an outer surface of the case, and exchanging heat with the cooling fluid.

The cooling plate may be attached to either the upper or lower surface of the case.

The cooling plate may be attached to each of two side surfaces of the case that is perpendicular to one direction of the battery cell.

### BRIEF DESCRIPTION OF THE DRAWINGS

FIG. 1 is an overall perspective view of a cylindrical type battery liquid immersion cooling system of the present disclosure.

FIG. 2 is a cross-sectional view of the cylindrical type battery liquid immersion cooling system of the present disclosure.

FIG. 3 is a graph showing a battery temperature change when using the cylindrical type battery liquid immersion cooling system of the present disclosure.

FIG. 4 is a top view showing a first embodiment of a fixing unit of the present disclosure.

FIG. 5 is a top view showing a second embodiment of a fixing unit of the present disclosure.

FIG. 6 is a top view showing a first embodiment of a cooling unit of the present disclosure.

FIG. 7 is a top view showing a second embodiment of a cooling unit of the present disclosure.

FIG. 8 is a top view showing a first embodiment of a cooling plate of the present disclosure.

FIG. 9 is a top view showing a second embodiment of a cooling plate of the present disclosure.

### DETAILED DESCRIPTION OF EMBODIMENTS

Hereinafter, the spirit of the present disclosure is described in more detail with reference to the accompanying drawings. Terms and words used in the specification and claims are not to be construed as general or dictionary meanings, and are to be construed as meanings and concepts meeting the spirit of the present disclosure based on a principle so that the inventors may appropriately define the concepts of terms in order to describe their inventions in the best mode.

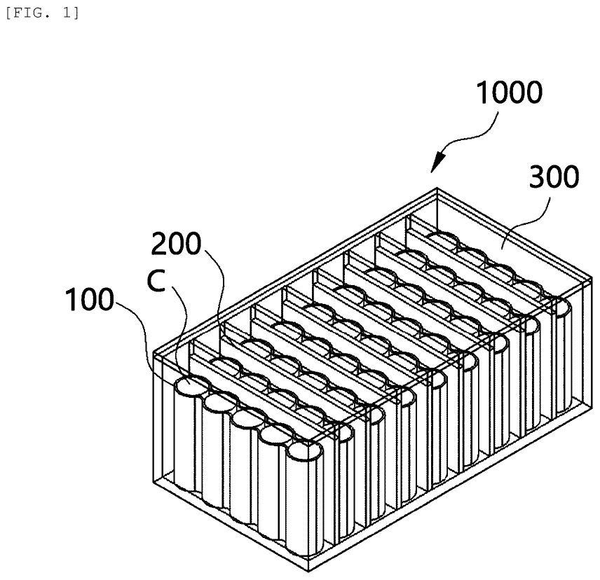

Hereinafter, the description describes a basic configuration of a cylindrical type battery liquid immersion cooling system 1000 of the present disclosure with reference to FIGS. 1 to 3.

As shown in FIG. 1, the cylindrical type battery liquid immersion cooling system 1000 of the present disclosure may cool a cylindrical type battery cell C by being in contact with a surface of the battery cell C, and in more detail, by including a cooling unit 100 cooling the battery cell C by being in direct contact with the battery cell C. The cooling unit 100 may be made of a porous absorbent member, and include a cooling fluid flowing the inside and outside thereof and cooling the battery cell C. The cooling unit 100 may also have electrical insulation and thermal conductivity. Accordingly, the cooling unit 100 may include at least one of glass fiber, polypropylene, and amorphous silica fiber. The system 1000 may have a lighter weight and simultaneously have higher cooling performance than a conventional liquid immersion cooling system by using the porous absorbent member in the cooling unit 100.

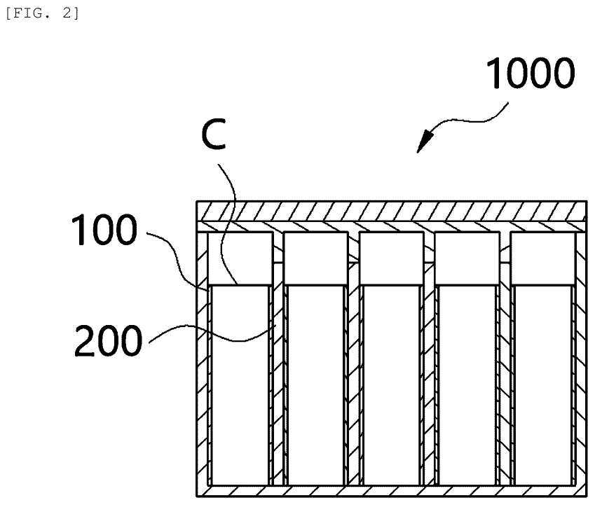

In addition, the cooling fluid included in the cooling unit 100 may be an insulating fluid or may be a non-reactive fluid. The cooling fluid may be, for example, hydrofluoroether (HFE). Accordingly, as shown in FIG. 2, the cooling fluid may absorb heat occurring from the battery cell C and cool the battery cell C through conduction, convection, and evaporation. To this end, the cooling fluid may need to be easily evaporated, and preferably have a low boiling point (of 50 to 60° C. or less).

In addition, the cylindrical type battery liquid immersion cooling system 1000 of the present disclosure may include a fixing unit 200. The fixing unit 200 may include a mounting part 210 in contact with the cooling unit 100 to attach the cooling unit 100 to the battery cell C. The fixing unit 200 may also include a partition 220 partitioning a space including at least one battery cell C. The cooling unit 100 may absorb heat of the battery cell C that occurs from a surface of the battery cell C by including the fixing unit 200.

In more detail, the partition 220 may provide a space including a unidirectional row of the battery cells C. The battery cell C included in the space partitioned by the partition 220 may preferably be cooled by the single cooling unit 100. It is thus possible to repeat the evaporation and condensation of the cooling fluid for each space that is partitioned by the partition 220, and perform continuous cooling with a limited amount of the fluid, thus achieving the higher cooling performance for the battery cell C by using latent heat of the evaporation.

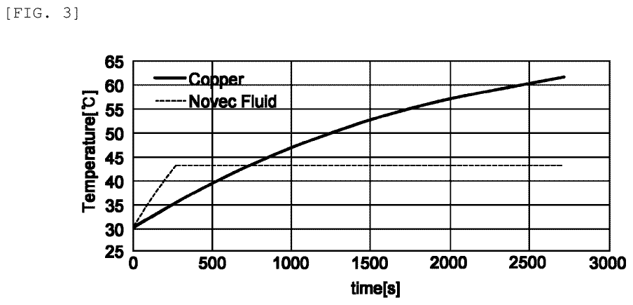

Hereinafter, in order to more substantially describe the above effect of the cylindrical type battery liquid immersion cooling system 1000 of the present disclosure, performed is a comparison of cooling performance of the cooling fluid of the cylindrical type battery liquid immersion cooling system 1000 of the present disclosure with that of a copper metal mainly used as a conventional heat conduction material. Here, the comparison is performed under the following assumption. Performed is the comparison of a case where a 3 mm thick copper metal or Novec 72DE which is the insulating fluid is in contact with the surface of the battery cell C. Here, it is assumed that heat with Qᵢₙ=Qₒᵤₜ+ΔU or Qᵢₙ=Q_{cell}=60 W may occur from the cell, a constant temperature of 25° C. is maintained outside, and the cooling is performed with a convective heat transfer coefficient h=300 W/m²·K. As a result of analyzing a battery temperature change over time under the above assumption, in the case of the conventional copper metal, the battery temperature is continuously increased to reach 56° C. after 30 minutes, whereas the insulating fluid used as the cooling fluid of the present disclosure evaporates at a boiling point of 43° C. or more and maintains a constant boiling point temperature. It may be seen that the NOVEC fluid has latent heat of the evaporation of h_{fg}=217.6 J/g, and dissipates 60 W of heat by the fluid evaporation of about m=0.276 g/s. This configuration is shown in FIG. 3.

In the above environment, the cylindrical type battery liquid immersion cooling system 1000 of the present disclosure may secure the heat dissipation of 60 W by the fluid evaporation of m=0.276 g/s. Here, required is 82.8 g of the cooling fluid for each cell. For the same performance, in the conventional case, the copper metal having a thickness of 3t corresponding to a mass of the battery cell C is required to be in contact with a side surface of the cell, and 124 g is a mass of the copper metal required here. That is, it may be seen that the cooling unit 100 of the cylindrical type battery liquid immersion cooling system 1000 of the present disclosure has a weight much lighter than the conventional system (about 4 kg difference per 100 battery cells C).

In addition, in the cylindrical type battery liquid immersion cooling system 1000 of the present disclosure, heat occurring while the cooling fluid is evaporated may be condensed again by a cooling plate 400 and the cooling fluid may thus be absorbed into the cooling unit 100. Accordingly, the system 1000 may not need to continuously supply the cooling fluid, thus reducing a required amount of the cooling fluid. Therefore, the cooling fluid may provide a higher gravimetric energy density to the cooling system.

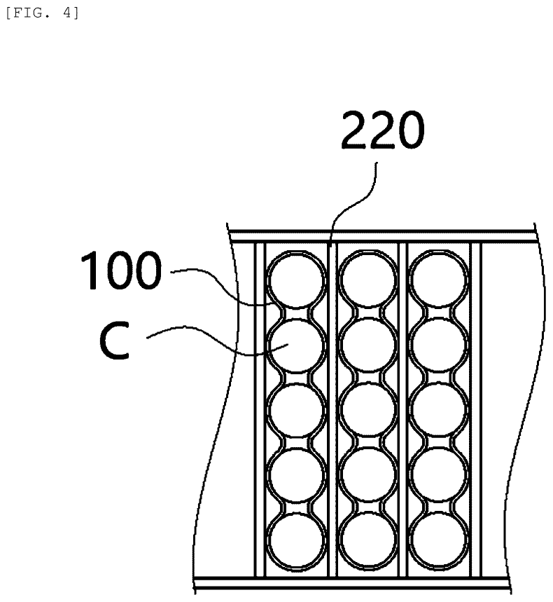

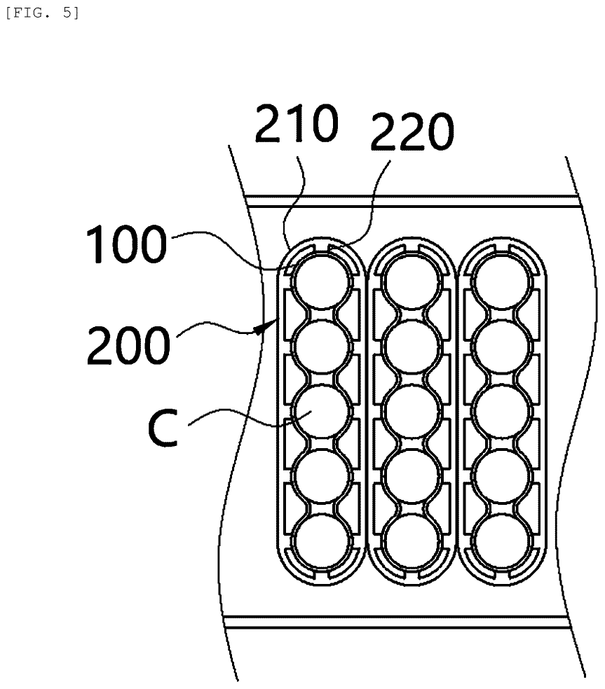

Hereinafter, the description describes embodiments of the fixing unit 200 of the present disclosure in more detail with reference to FIGS. 4 and 5.

In a first embodiment of the fixing unit 200 shown in FIG. 4, the partition 220 may be a flat plate extending in one direction and sandwiched between the unidirectional rows of the battery cells C. The partition 220 may be disposed inside a case 300 described below, and both ends thereof may thus be in contact with surfaces of the case 300 that oppose each other. Here, the case 300 may further include a step disposed on the inside of an upper surface and in contact with the partition 220. Accordingly, an upper space of the battery cell C may also be partitioned by the step disposed on the upper surface of the case 300. In addition, in an embodiment of a coupling relationship between the partition 220 and the case 300, for example, the partition 220 may have a protrusion or a groove, disposed on or in a surface in contact with the case 300, to be assembled to the case 300. The case 300 may also have a corresponding protrusion or groove disposed on or in a portion in contact with the partition 220.

Here, the mounting part 210 may be a portion where the partition 220 and the battery cell C are in contact with each other. In more detail, different unidirectional rows of the battery cells C may be in contact with both sides of the partition 220, and a position of the partition 220 may be maintained by a pressure applied from both the sides in contact with the battery cell C.

The system using a first embodiment of the fixing unit 200 may partition a region including the battery cell C through a simpler manufacturing process, and maintain a certain amount of cooling fluid in one cooling unit 100 by repeating the evaporation and condensation of the cooling fluid in a region surrounded by the partition 220 and the case 300.

In a second embodiment of the fixing unit 200 shown in FIG. 5, the partition 220 may be a plate surrounding the unidirectional rows of the battery cells C. In more detail, the partition 220 may be a plate having open top and bottom, having a shape of a side surface at least partially corresponding to that of the unidirectional row of the battery cells C, and including a curved surface. Here, the side surface of the partition 220 may face the side surface of the cylindrical type battery cell C, and the upper or lower side of the partition 220 may face a bottom surface of the cylindrical type battery cell C.

Here, the mounting part 210 may be a step protruding from the partition 220 to the battery cell C. The mounting part 210 may be detachable from the partition 220 or integral with the partition 220. The partition 220 may include the mounting part 210 to thus apply the pressure to the cooling unit 100 as much as an area of the protruding mounting part 210, and allow the cooling unit 100 to be more effectively attached to the battery cell.

The system using a second embodiment of the fixing unit 200 may widely secure the battery cell C and its neighboring region in partitioning the region including the battery cell c, and minimize interference between the different unidirectional rows of the battery cells. The system may maintain a certain amount of cooling fluid in one cooling unit 100 by repeating the evaporation and condensation of the cooling fluid in a region surrounded by the partition 220 and the case 300.

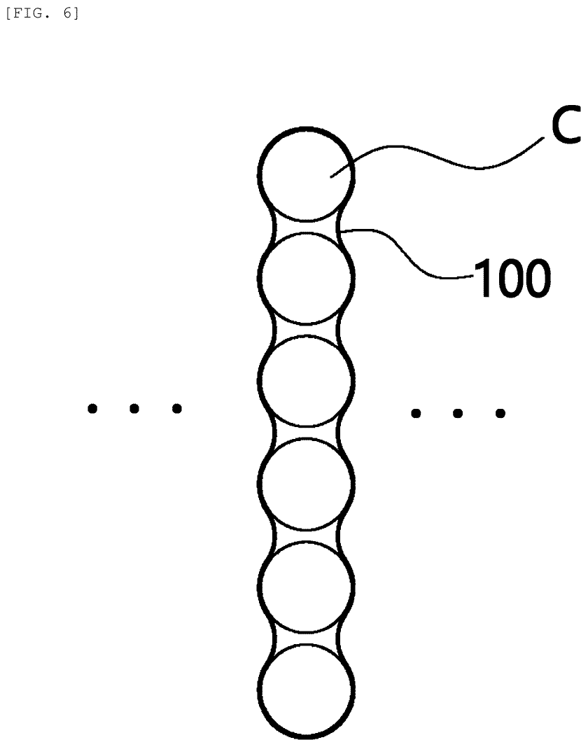

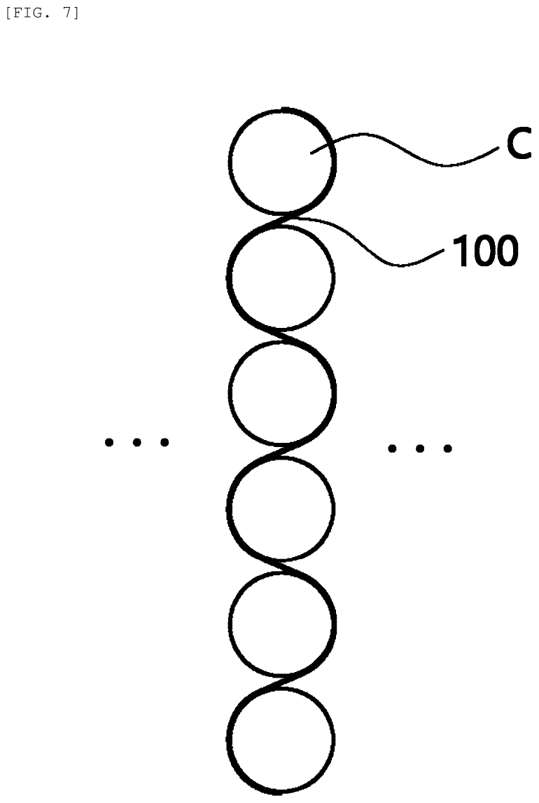

Hereinafter, the description describes embodiments of the cooling unit 100 of the present disclosure in more detail with reference to FIGS. 6 and 7.

In a first embodiment of the cooling unit 100 shown in FIG. 6, the cooling unit 100 may have a shape of a closed strip including all of the unidirectional rows of the battery cells C inside. Here, the cooling unit 100 may have one surface corresponding to the side surface of the unidirectional row of the battery cells C to thus cover the entire side surface of the battery cell C.

Here, a thickness direction of the cooling unit 100 may be a height direction of battery cell C, and a length of the cooling unit 100 in the thickness direction may be the same as or longer than a height of the battery cell C within a predetermined error range. The system may adopt a first embodiment of the cooling unit 100 to thus maximize a contact area between the cooling unit 100 and the battery cell C, thus easily transferring heat occurring in the battery cell C to the cooling unit 100.

In addition, in a second embodiment of the cooling unit 100 shown in FIG. 7, the cooling unit 100 may be an open strip extending in one direction, and a thickness direction of the cooling unit 100 may be a height direction of the battery cell C, and a length of the cooling unit 100 in the thickness direction may be the same as or longer than a height of the battery cell C within a predetermined error range.

More specifically, the cooling unit 100 may be in contact with the battery cell C by being attached to one side of a side surface of a first battery cell C which is one of the battery cells C, and attached to the other side of a side surface of a second battery cell C which is included in the same row as that of the first battery cell C and adjacent to the first battery cell C. That is, the cooling unit 100 may be attached to the battery cell C in a zigzag manner when viewed from the top. The system may adopt a second embodiment of the cooling unit 100 to uniformly absorb heat occurring in the battery cell C for heat not to be concentrated in one portion while minimizing the weight and volume of the cooling unit 100.

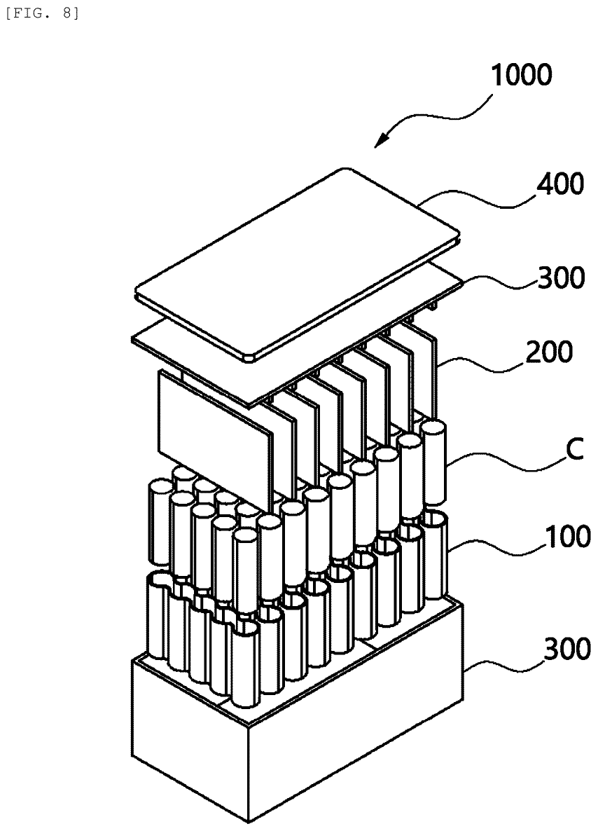

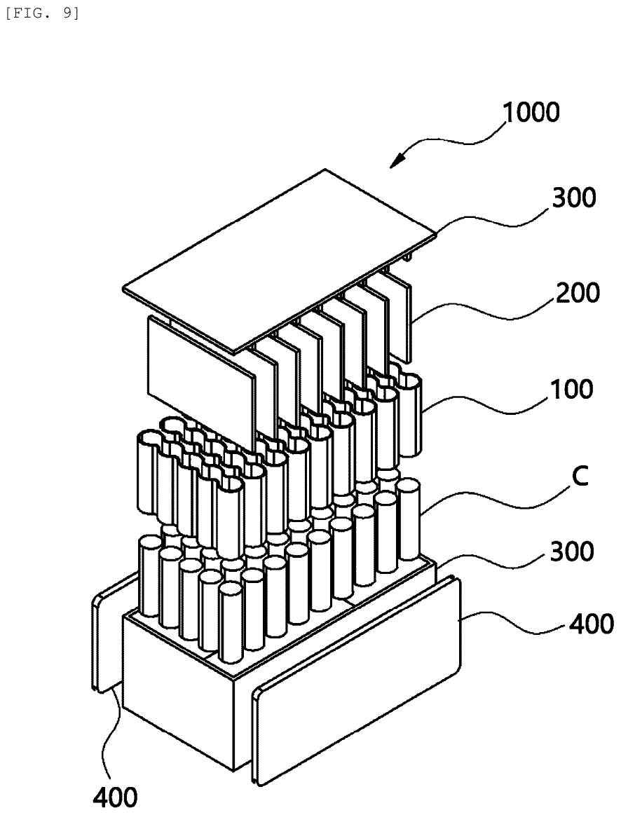

Hereinafter, the description describes the case 300, cooling plate, their embodiments of the present disclosure with reference to FIGS. 8 and 9.

The cylindrical type battery liquid immersion cooling system 1000 of the present disclosure may further include: the case 300 embedding the plurality of battery cells C, the cooling unit 100, and the fixing unit 200 inside; and the cooling plate 400 attached to an outer surface of the case 300 to cool the battery cell C and condense the cooling fluid. The cooling plate 400 may be attached to the outer surface of the case 300 to cool the battery cell C and condense the cooling fluid included in the cooling unit 100. Accordingly, even when the cooling fluid included in the cooling unit 100 changes its phase by absorbing heat occurring in the battery cell C, the cooling fluid may be re-cooled by the cooling plate 400 and condensed in the cooling unit 100 again. Accordingly, the cylindrical type battery liquid immersion cooling system of the present disclosure may continuously evaporate and condense the cooling fluid inside the case 300, perform the continuous cooling with the limited amount of the fluid, and achieve the higher cooling performance for the battery cell C by using the latent heat of the evaporation.

Here, in a first embodiment of the cooling plate 400 shown in FIG. 8, the cooling plate 400 may preferably be attached to either the upper or lower surface of the case 300. Here, the upper or lower surface of the case 300 may be a surface of the case 300 that is in contact with or faces the bottom surface of the cylindrical type battery cell C. The system may use a first embodiment of the cooling plate 400 to cause the evaporation and condensation of the fluid only in the fixing unit 200, and the liquefied cooling fluid vapor to uniformly return to each cooling unit 100.

Alternatively, in a second embodiment of the cooling plate 400 shown in FIG. 9, the cooling plate 400 may be attached to each of two side surfaces of the case 300 that is perpendicular to one direction of the battery cell C. Here, the side surface of the case 300 may be any of the two surfaces of the case 300 that oppose each other except for its upper and lower surfaces described above.

When the cooling plate 400 is disposed on only one side surface of the case 300, the cooling fluid may be biased to the cooling unit 100 close to the cooling plate 400, and condensed and absorbed thereby. Therefore, the cooling plate 400 may preferably be disposed on each of the two side surfaces for the cooling fluid to be uniformly absorbed thereby. The system using a second embodiment of the cooling plate 400 may increase a heat exchange area between the cooling unit 100 and the cooling plate 400, thus more efficiently liquefying the cooling fluid to return to the cooling unit 100.

As set forth above, the cylindrical type battery liquid immersion cooling system of the present disclosure having the above configuration may have the lighter weight and the higher cooling performance than the conventional liquid immersion cooling system by using the absorbent material including the cooling fluid inside.

In addition, the cylindrical type battery liquid immersion cooling system of the present disclosure may be continuously cooled with the limited amount of the fluid by evaporating and condensing the cooling fluid included in the absorbent material, and may achieve the higher cooling performance by using the latent heat of the evaporation.

The spirit of the present disclosure should not be limited to the embodiments described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. A cylindrical type battery liquid immersion cooling system, the system comprising:
a cooling unit configured to cool at least one battery cell by being in contact with a surface of the battery cell; and
a fixing unit configured to support the cooling unit including a mounting part and a partition, the mounting part being in contact with the cooling unit and configured to attach the cooling unit to the battery cell, and the partition configured to partition a space including the at least one battery cell,
wherein the cooling unit includes a porous absorbent member including a cooling fluid flowing through an inside and an outside thereof and cooling the at least one battery cell.

2. The cylindrical type battery liquid immersion cooling system of claim 1, wherein the partition provides a space including a unidirectional row of the battery cells, and
the battery cell included in the space partitioned by the partition is cooled by the cooling unit.

3. The cylindrical type battery liquid immersion cooling system of claim 2, wherein the partition is a flat plate extending in one direction and sandwiched between the unidirectional rows of the battery cells.

4. The cylindrical type battery liquid immersion cooling system of claim 2, wherein the partition is a plate having open top and bottom, having a side surface at least partially corresponding to that of the unidirectional row of the battery cells, and including a curved surface.

5. The cylindrical type battery liquid immersion cooling system of claim 4, wherein the mounting part is a step protruding from the partition to the battery cell.

6. The cylindrical type battery liquid immersion cooling system of claim 2, wherein the cooling unit has a shape of a closed strip including all of the unidirectional rows of the battery cells inside, corresponding to a side surface of the unidirectional row of the battery cells to cover an entire side surface of the battery cell, and having the same thickness as a height of the battery cell.

7. The cylindrical type battery liquid immersion cooling system of claim 2, wherein the cooling unit has a shape of an open strip having the same thickness as a height of the battery cell,
is attached to one side of a side surface of a first battery cell which is one of the battery cells, and
is attached to the other side of a side surface of a second battery cell which is included in the same row as that of the first battery cell and adjacent to the first battery cell.

8. The cylindrical type battery liquid immersion cooling system of claim 1, further comprising:
a case embedding the at least one battery cell, the cooling unit, and the fixing unit inside; and
a cooling plate attached to an outer surface of the case, and configured to exchange heat with the cooling fluid.

9. The cylindrical type battery liquid immersion cooling system of claim 8, wherein the cooling plate is attached to either an upper or a lower surface of the case.

10. The cylindrical type battery liquid immersion cooling system of claim 8, wherein the cooling plate is attached to each of two side surfaces of the case that is perpendicular to one direction of the battery cell.
